(19) United States
(12) Patent Application Publication
(10) Pub. No.: US 2009/0171689 A1
(43) Pub. Date: Jul. 2, 2009

(54) Process and software for distribution of communications in a relational context utilizing the Internet

(76) Inventors: Esteban Guillermo Gallegos, Dallas, TX (US); Michael Edwin Clarke, Dallas, TX (US); Joshua John Osteen, Frisco, TX (US); Roy Clinton Womack, Carrollton, TX (US)

Correspondence Address: Esteban Guillermo Gallegos, CEO;The Business Friends Forever Network, LLC, 5028 Village Circle, Dallas, TX, 75248, US

(21) Appl. No.: 12/313,885

(22) Filed: Nov. 25, 2008

Related U.S. Application Data
(60) Provisional application No. 61/004,196, filed on Nov. 26, 2007.

(51) Int. Cl. G06Q 99/00

(52) U.S. Cl. 705/1

(57) ABSTRACT

A process and software for the distribution of communications in a relational context utilizing the Internet with the steps of: Each person sends an electronic newsletter to their list of personal/business contacts, each person's profile is carried on the newsletter of the first level (Parent 1) person he is in relation to, each person's profile is carried on the newsletter of the second level (Parent 2) person he is in relation to, each person's profile is carried on the newsletter of the third level (Parent 3) person he is in relation to, each person's profile is carried on the newsletter of the fourth level (Parent 4) person he is in relation to, and each person's profile is carried on the newsletter of the fifth level (Parent 5) person he is in relation to.

### CROSS REFERENCE TO RELATED APPLICATIONS

This application is based on provisional application Ser. No. 61/004,196, filed on Nov. 26, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of communications using the Internet, and more specifically to a process and software for the intelligent distribution of communications in a relational context utilizing the Internet.

### BACKGROUND

In recent years, the Internet has been a hotbed of social networking activity sparked by web sites such as MySpace and Facebook. As a result, millions of small business entrepreneurs are flocking to post profiles on these sites in hopes of attracting new consumers for their products and services. Painfully, these same entrepreneurs are learning that after investing hundreds of hours collecting “friends” and linking profiles, they are nowhere closer to gaining new customers from these sites than when they started. It seems that while these social networks allow the open exchange of personal photos and music, they prohibit users from communicating with other members of the same network for the purpose of promoting their goods and services, even if they have agreed to link profiles. Thus, the small business owner is effectively precluded from using existing social networking sites to market their products and services.

While there exist web sites that are designed to facilitate networking between members who are business owners, these sites as well, do not permit a member to communicate with other members for the purpose of marketing their products and services.

The problem stems from the fact that the vast majority of users of existing social and business networking sites are not in relation to one another, meaning they are complete or relative strangers.

There exists an opportunity for an Internet company which facilitates the marketing of a member's products and services to other members and to the end consumer on a relational basis.

### The Solution:

A process and application program for marketing exposure, utilizing the Internet. Members are given communication tools to build a relational context network that exposes the members business information to up to millions of warm market consumers per week.

The introductions are made via a process which generates a “people newsletter” (FIG. 1) and a complementary process which distributes the newsletter via the Internet and is received by persons that are within the relational matrix of the sender. (FIG. 6)

### BRIEF SUMMARY OF THE INVENTION

The primary object of the invention is to provide a process for communicating business profile information on the Internet.

Another object of the invention is to provide a process for communicating on the Internet which links multiple persons on a relational basis.

Another object of the invention is to provide a process for communications on the Internet between one individual and the personal and business contacts of other individuals he is in relation to.

A further object of the invention is to provide a process for communications between one individual and the personal/business contacts of other individuals he/she is in relation to, free from claims of spam.

Still yet another object of the invention is to provide a system of personal introductions across the Internet between one individual to the contacts of other individuals he/she is in relation to while maintaining confidentiality of those contacts.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process and software for distribution of communications in a relational context utilizing the Internet, comprising the steps of:

An electronic newsletter (FIG. 2) is created on behalf of a member (FIG. 3).

An Individual Member (FIG. 1, 1100) sends an electronic newsletter to their list of personal/business contacts (FIG. 4, 1402).

Each member's profile is carried on the newsletter of the first level of “Invited Members” (FIG. 1, 1101).

Each member's profile is carried on the newsletter of the second level of “Invited Members” (FIG. 1, 1102).

Each member's profile is carried on the newsletter of the third level of “Invited Members” (FIG. 1, 1103).

Each member's profile is carried on the newsletter of the fourth level of “Invited Members” (FIG. 1, 1104).

Each member's profile is carried on the newsletter of the fifth level of “Invited Members” (FIG. 1, 1105).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a tree diagram of the embodiment of the relational matrix simplified by showing one branch only.

FIG. 2 is a wire frame embodiment describing HTML “people newsletter” document.

FIG. 3 is a flow chart of the method for generating the “people newsletter”.

FIG. 4 is a flow chart of the method for distribution of the newsletter.

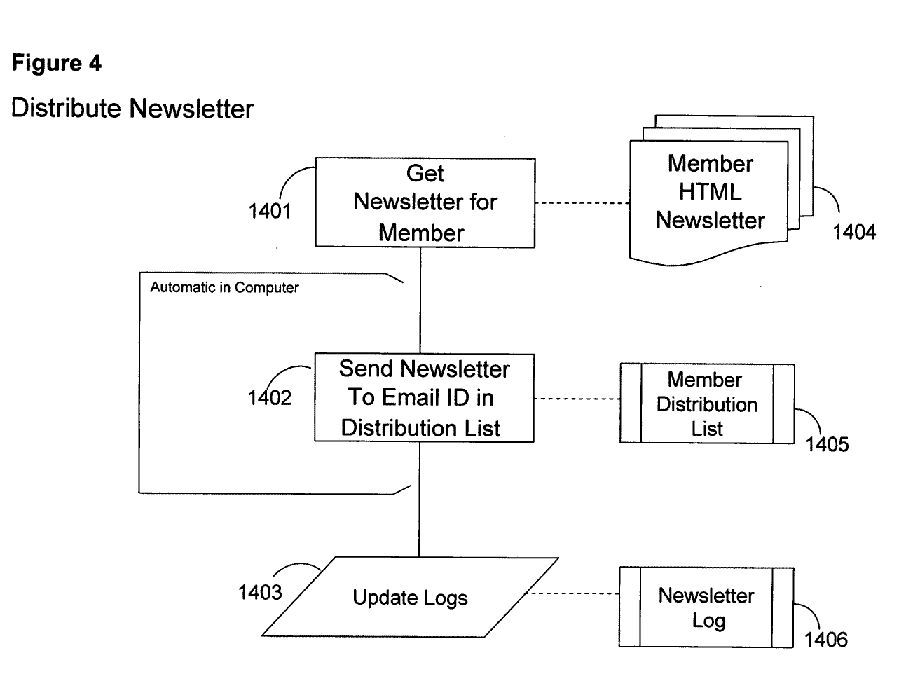

FIG. 5 depicts a database interaction with the Member.

FIG. 6 depicts an internet interaction with the Subscriber.

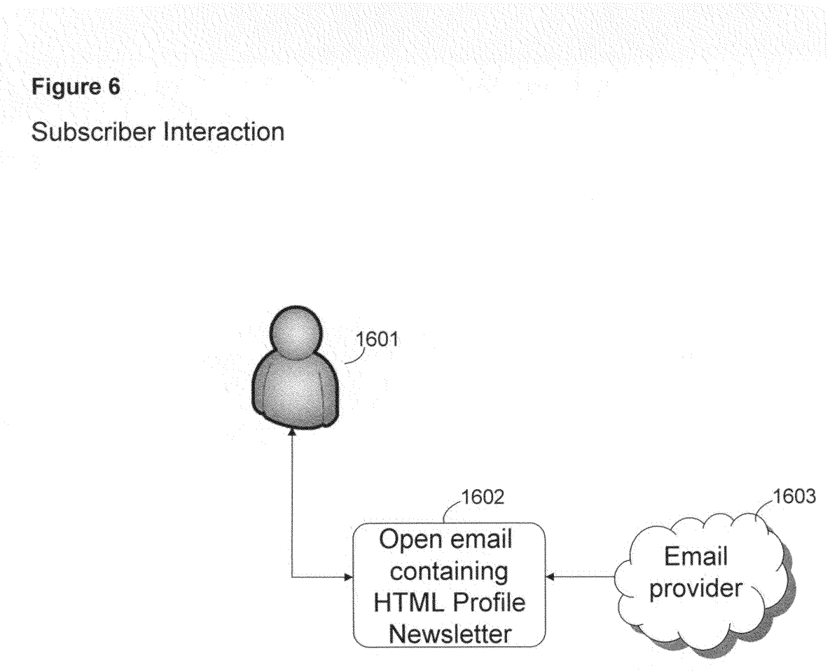

FIG. 7 is block diagram of a computerized system embodying the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

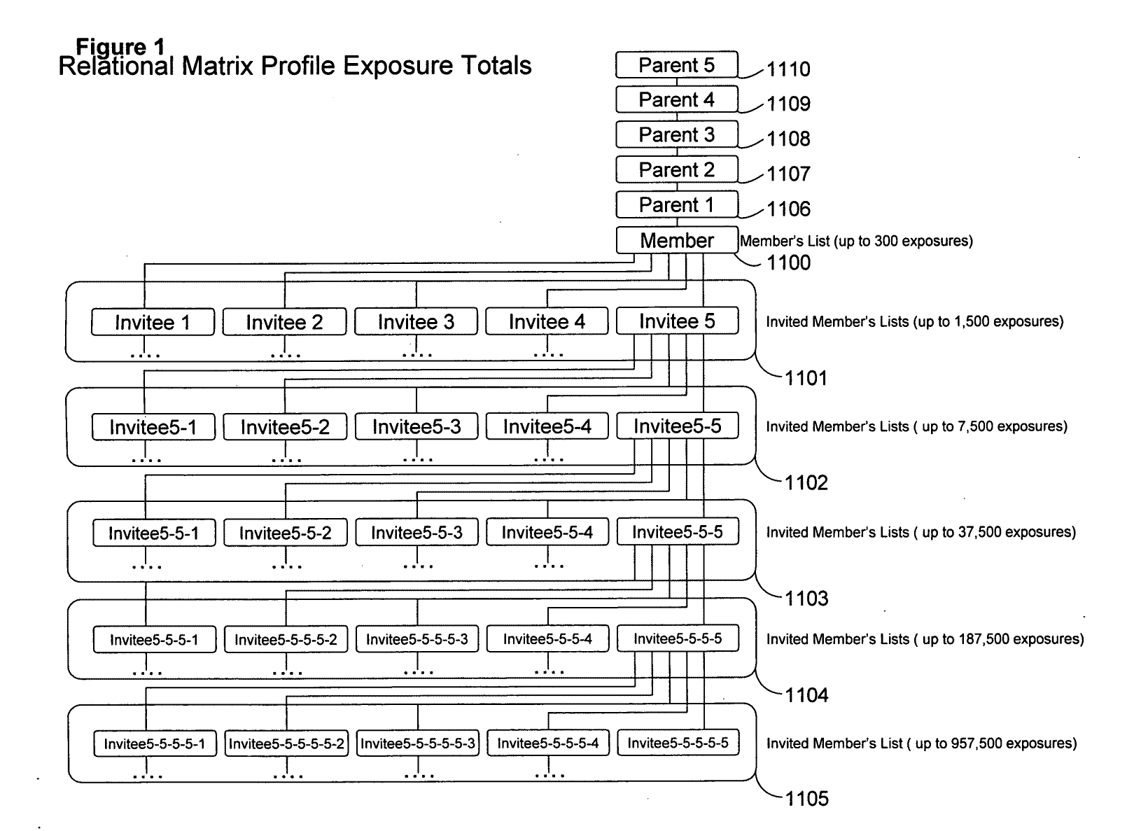

In accordance with certain exemplary embodiments of the present invention, a process and software for distribution of communications in a relational context utilizing the Internet, FIG. 1, shows the process and flow volume of communications by a member of the network and the distribution of those communications to persons that are in the member's relational matrix.

By way of illustration, the invention which embodies a process and software for distribution of communications in a relational context utilizing the Internet comprising of the following steps:

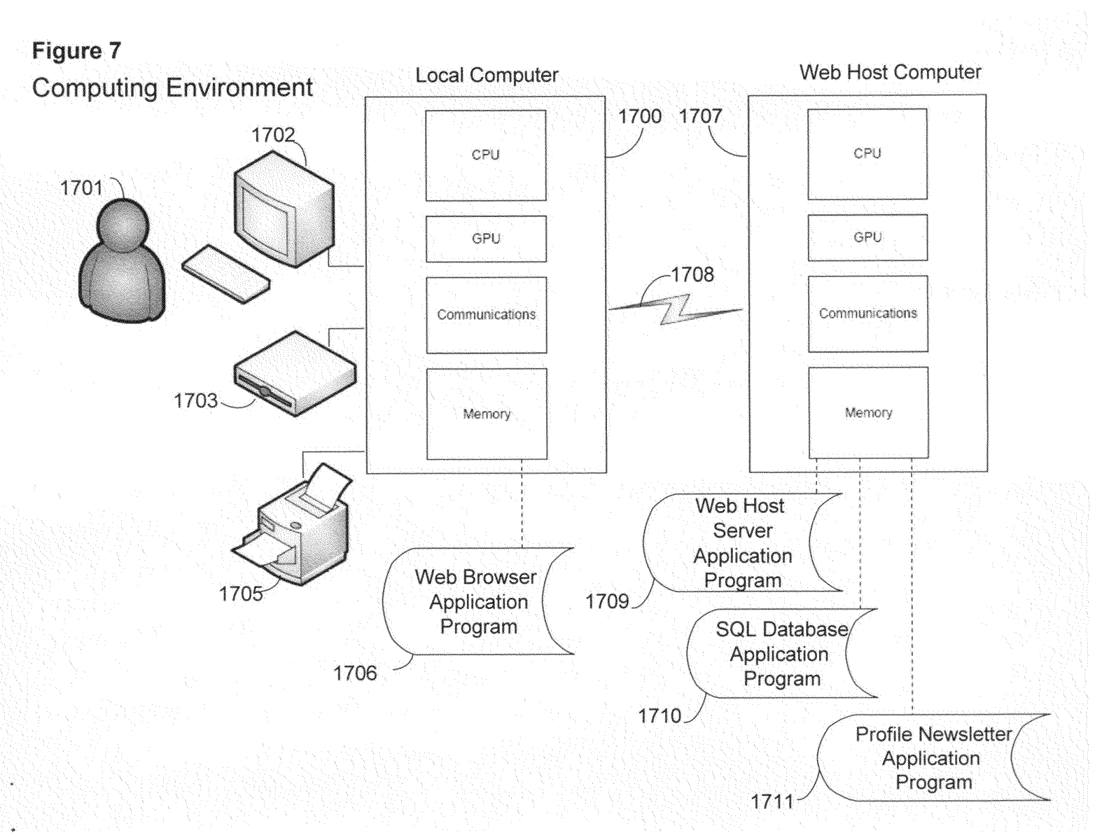

The automatic newsletter system is implemented as application program software on an internet host server on the worldwide web. (FIG. 7, 1711)

The Member (FIG. 1) 1100 is business owner who joins our business network and invites 5 others into the network 1101, each of whom also invite five other business owners into the network 1102. Member 1100 utilizes our system to generate a newsletter free of editorial content.

The newsletter carries a video/audio profile of member 1100 which is distributed to his/her personal contacts, and is also distributed to the personal contacts of the invited members 1101 (Invitee 1), 1102 (Invitee 2), 1103 (Invitee 3), 1104 (Invitee 4) and 1105 (Invitee 5) on the newsletter generated by each with our software.

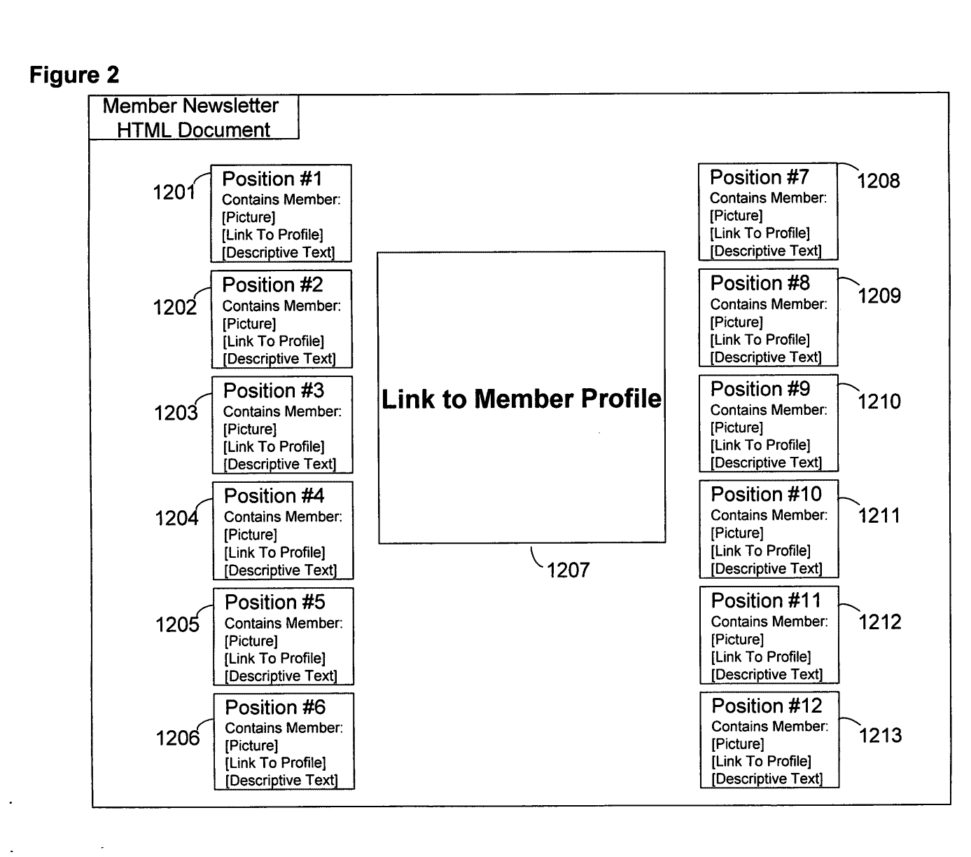

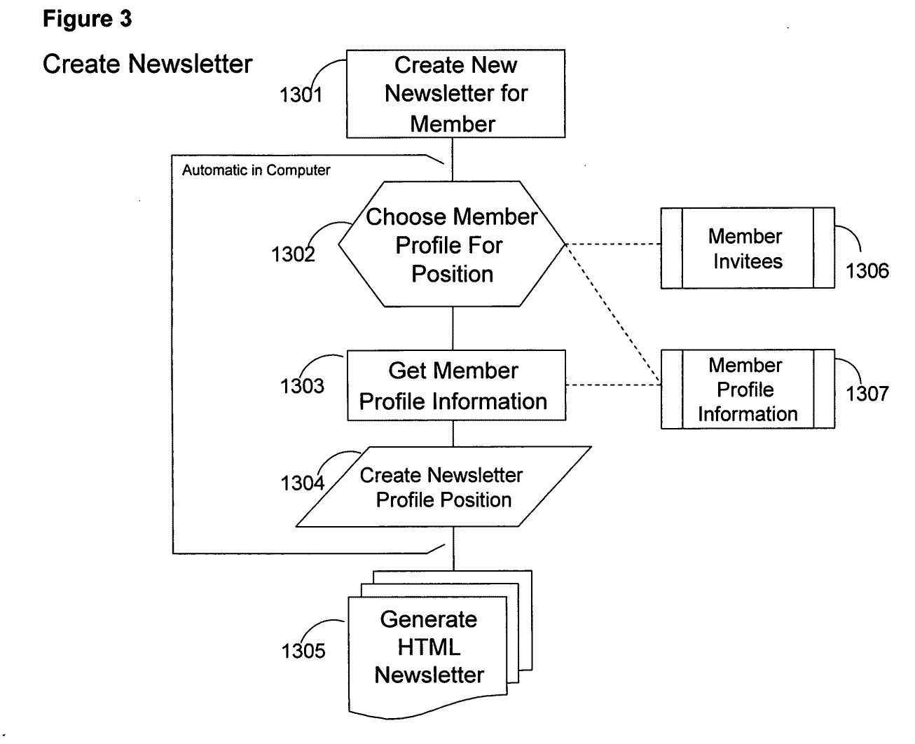

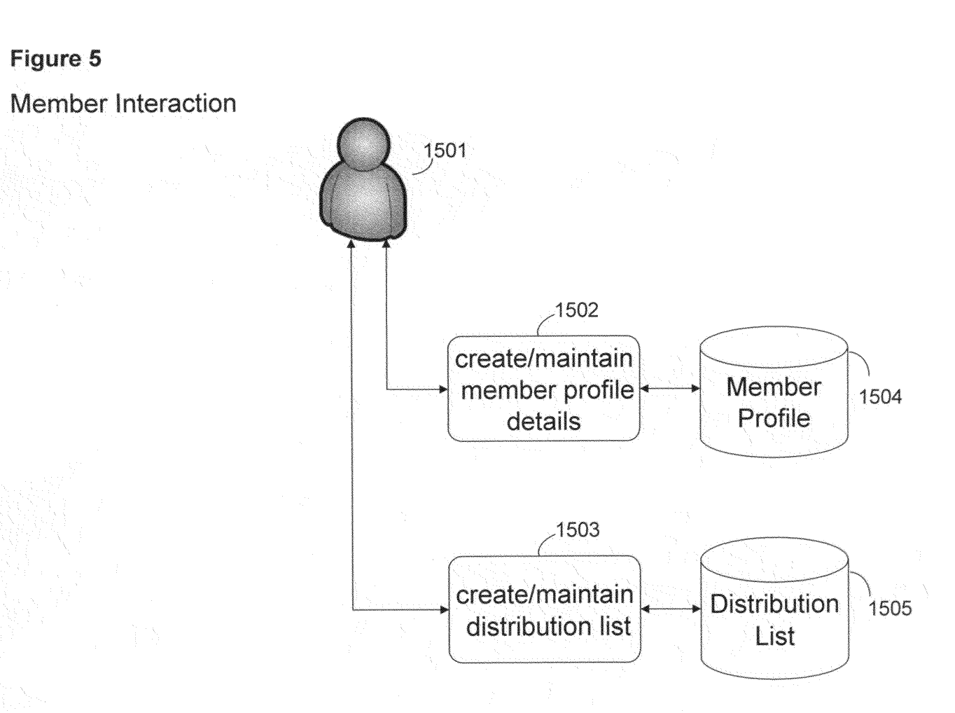

Another exemplary embodiment of the invention which embodies a process and software for distribution of communications in a relational context utilizing the Internet is shown in FIG. 2, The Member Newsletter. The Newsletter described is an HTML implementation of the embodiment, and has 12 positions, numbered 1 thru 12 for this diagram. Position #1 (FIG. 1) 1201 is the business profile information for the member sending the newsletter. Position #2 1202, through Position #6 1206, are the members invited by the newsletter owner or a randomly chosen business profile. Position #7 thru Position #11 (1208-1212) are parent members to the newsletter owner (FIG. 1, 1106-1110) or a randomly chosen business profile. The newsletter is created by an automatic generation process (FIG. 3) that begins after the Member uploads business contact profile data into the system (FIG. 5) comprising of the following steps: member 1501 is a small business owner that joins the network. He creates a profile on the network and uploads the names and email addresses of up to three hundred of his personal contacts. The profile of member 1501 is sent electronically via the Internet to his three-hundred contacts. Since this member (FIG. 1, 1100) has invited five other persons (1101) into the network and each has uploaded 300 names and email addresses of their personal contacts into the system, the profile of member: (FIG. 1, 1100) is carried by first all members invited (FIG. 2 1101) up to 1,500 contacts, additionally, the profile of member 1101 is carried by the next level of members (FIG. 2 1102), invited by the members in previous level 1101 for a total up to 7,500 contacts, additionally, the profile of member 1101 is carried by the next level of members (FIG. 2 1103), invited by the members in previous level 1102 for a total up to 37,500 contacts, additionally, the profile of member 1101 is carried by the next level of members (FIG. 2 1104), invited by the members in previous level 1103 for a total up to 187,500 contacts, additionally, the profile of member 1101 is carried by the next level of members (FIG. 2 1105), invited by the members in previous level 1104 for a total up to 957,500 contacts.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process and software for the distribution of communications in a relational context utilizing the Internet comprising the steps of:
Each member has an electronic newsletter created on their behalf;
Each member sends an electronic newsletter to their list of personal/business contacts;
Each member's profile is carried on the newsletter of all the members invited by this member, including the members invited by those members for up to 5 generations of members he is in relation to.
